(19) United States
(12) Patent Application Publication
(10) Pub. No.: US 2024/0186793 A1
(43) Pub. Date: Jun. 6, 2024

(54) INTERMEDIATE POWER STORE FOR POWER GENERATING SYSTEMS

(71) Applicant: TECHNISCHE UNIVERSITÄT DARMSTADT, Darmstadt (DE)

(72) Inventors: Falah Alobaid, Darmstadt (DE); Pascal Koschwitz, Berlin (DE); Bernd Epple, Brensbach (DE)

(21) Appl. No.: 18/283,869

(22) PCT Filed: Mar. 21, 2022
(86) PCT No.: PCT/EP2022/057377

§ 371 Date: Sep. 25, 2023

(30) Foreign Application Priority Data
Mar. 25, 2021 (DE) 10 2021 107 575.0

(51) Int. Cl. H02J 3/38; B01D 61/02; B01D 61/06; B01D 61/08; B01D 61/12; F03G 7/00; H02K 7/18; H02S 10/12

(52) U.S. Cl. CPC H02J 3/38; B01D 61/025; B01D 61/06; B01D 61/08; B01D 61/12; F03G 7/015; H02K 7/183; H02S 10/12; B01D 2313/243; B01D 2313/246; B01D 2313/501; B01D 2313/502; H02J 2300/24; H02J 2300/28

(57) ABSTRACT

An intermediate power store for at least one power generating system, including: an osmosis device, a permeate store, a concentrate store and a control device. The osmosis device is designed to separate, in a charging operation, a liquid mixture with a charging pressure into a permeate and a concentrate, or, in a discharging operation, to mix the permeate with the concentrate while applying an osmotic pressure to the liquid mixture. The permeate store is fluidically connected to the osmosis device and is designed to store the permeate. The concentrate store is fluidically connected to the osmosis device and is designed to store the concentrate. The control device is designed to control the following functions: the charging operation using electrical power from the at least one power generating system, or the discharging operation while providing electrical power.

### PRIORITY CLAIM

The present application is a National Phase entry of PCT Application No. PCT/EP2022/057377, filed Mar. 21, 2022, which claims priority from German Patent Application No. 10 2021 107 575.0, filed Mar. 25, 2021, the disclosures of which are hereby incorporated by reference herein in their entirety.

### FIELD OF THE INVENTION

The present invention relates to an intermediate power store (energy buffer) and a method for buffering energy, and more particularly to a hybrid osmotic pumped storage system for wind power plants or for photovoltaic power generation plants or other power generation plants from time-varying forms of energy.

### BACKGROUND

There is great interest in generating 100% of electricity and heat from renewable energies in the future. However, these forms of energy fluctuate in terms of location and time, which promotes and necessitates the expansion of energy storage systems in order to achieve a smoothing of the energy supply.

Energy storage devices can be classified as chemical, thermal, mechanical or electrical. Hybrid energy storage systems are storage systems that can be classified as two or more of the four categories. Most storage systems comprise both advantages and disadvantages in terms of storage characteristics, such as capacity, reconversion/storage efficiency, economic efficiency, withdrawal and injection time, suitability as long-term storage, cycle stability, location dependence, lifetime, gravimetric and volumetric storage density, and life cycle assessment.

Despite recent advances in accumulators (rechargeable batteries), the specific costs of such storage systems still limit them to small-scale applications, especially for longer storage durations. Thermal storage systems are almost always associated with losses, since once heat is generated it cannot be fully converted back into electrical work. The same is true for chemical storage systems, since chemical reactions also generate heat that is at least partially lost.

Therefore, there is a need for alternative energy storage systems and especially for hybrid systems that combine different concepts in order to avoid specific disadvantages of individual concepts.

### SUMMARY OF THE INVENTION

At least some of the above problems are overcome by an energy buffer according to the independent claims. The dependent claims relate to advantageous further embodiments of the subject matters of the independent claims.

The present invention relates to an energy buffer for at least one power generation plant from a time-varying energy source. The energy buffer includes: an osmosis device, a permeate reservoir (store), a concentrate reservoir (store), and a control device. The osmosis device is configured to, in a loading process, separate a mixed liquid with a loading pressure into a permeate and a concentrate and/or, in an unloading process, mix the permeate with the concentrate while providing an osmotic pressure to form the mixed liquid. The permeate reservoir is in fluid communication with the osmosis device and is configured to store the permeate. The concentrate reservoir is fluidly in communication with the osmosis device and is configured to store the concentrate. The control device is configured to control the following functions: the loading process utilizing electrical energy from the at least one power generation plant and/or the unloading process while providing electrical energy. The provided osmotic pressure can be utilized, for example, to generate electricity. The utilized energy may also come from a power grid.

According to embodiments, the power generation plant is a wind power plant or a photovoltaic plant or a hydroelectric plant or a geothermal-powered thermal power plant or a combination thereof. A combination of wind power plants and photovoltaic plants can be utilized, for example, to reduce variability in time-varying energy.

In the loading process, the mixed water (especially salt water) is pumped, for example, from a reservoir at the loading pressure to the osmosis device using the energy of the power generation plant (or the power grid), which is then operated in a reverse osmosis mode. In the unloading process, the equipment is operated in forward osmosis and the osmotic pressure of the mixed concentrate and permeate is provided for power generation.

Optionally, the energy buffer includes a pressure exchanger configured to partially utilize an osmosis device outlet pressure for the concentrate to generate the osmosis device charging pressure.

Optionally, the concentrate reservoir is arranged above the permeate reservoir to keep a hydrostatic pressure of the permeate lower than a hydrostatic pressure of the concentrate. It is advantageous if the concentrate reservoir is located as high as possible, since in this way a high energy density can be comprised or as much as possible of the load pressure can be utilized for pumping up.

Optionally, the energy buffer includes at least one of the following: a first pump, a second pump, a third pump, one or more valve units, a reservoir. The first pump and/or the third pump are configured to bring the loading pressure at the mixed liquid osmosis device to a predetermined value above the osmotic pressure during the loading process. The second pump is configured to feed concentrate from the concentrate reservoir to the osmosis device at a predetermined concentrate pressure during the unloading process. The one or more valve units are configured to control one or more of the following flows: Mixed liquid flow, permeate flow, concentrate flow. The reservoir stores the mixed liquid to provide a closed liquid loop.

Optionally, the control device is further configured to control at least one of the following functions:
starting the loading process in response to a loading signal indicating an excess of electrical energy;
starting the unloading process in response to an unload signal indicating a lack of electrical energy;
actuating the first pump and/or the second pump and/or the third pump and/or the valve units to achieve the predetermined boost pressure and/or the predetermined concentrate pressure.

The surplus/lack of electrical energy can come from the fluctuating power generation plant itself, or from other plants, or from the power grid, and is controlled by the output of appropriate signals (load signal, unload or discharge signal). In particular, several energy storage units can be combined. The aim is for the one or more power generation plants to supply electrical energy as constantly as possible.

During the loading process, the first pump and/or the third pump can be activated to generate the loading pressure. The loading pressure should be higher than the osmotic pressure in order to achieve a separation of concentrate and permeate. During the unloading process, due to forward osmosis, an overpressure is established on the concentrate side, which is defined by the osmotic pressure and can comprise a considerable value depending on the concentration difference, e.g., across a membrane. To prevent backflow and achieve effective fluid flow through the osmosis device, it has been found advantageous for the concentrate pressure to exceed a minimum value (e.g., half the osmotic pressure during unloading). It is understood that the osmotic pressure is essentially a physicochemical result, e.g., from the concentration, the liquid, the ingredients, the temperature. Depending on the specific conditions, the concentrate pressure can be determined by optimization in terms of energy supply.

The osmosis device may comprise at least one membrane configured to separate the mixed liquid at a concentration of at least 3% or at least 5% into the permeate and the concentrate. The osmosis device may also comprise multiple stages to perform stepwise separation. By proceeding stepwise, for example, the mechanical pressure on the membrane can be limited.

Optionally, the (at least one) membrane is configured to allow operation with a concentration of the concentrate of at least 10% or of at least 20%.

Optionally, the mixed liquid is a pure salt solution (e.g., water, H2O, with common salt, NaCl) and the energy buffer is a closed system with no mass transfer with the environment. However, the invention is not intended to be limited to certain mixed liquids. In principle, sugar or other liquids can also be taken as pure water. However, it is advantageous if the mixed liquid is as pure as possible.

Further embodiments relate to a power generation plant such as a wind power plant, a photovoltaic power plant, a hydroelectric power plant, a geothermal powered thermal power plant, or a combination thereof, that comprises an energy buffer as previously described.

Optionally, the energy buffer in the exemplary wind turbine is a hybrid energy storage system in which the permeate reservoir is optionally located below the concentrate reservoir in a tower of the wind turbine, and the concentrate reservoir for the mixed liquid is arranged on or below an earth surface or water surface. This achieves a hybrid energy storage system as a combination of osmotic energy storage with mechanical pumped storage. The same concept can be implemented for photovoltaic systems. For example, if the photovoltaic system is installed on a house, the height differences (e.g. of the roof compared to the basement) can be utilized like the tower of wind turbines.

Optionally, the power generation plant or energy buffer includes a turbine configured to utilize the osmotic pressure of the mixed liquid generated by the osmosis device to generate electrical power.

Optionally, the control device is further configured to receive a control signal and, based thereon, start the loading process and/or the unloading process. The control signal may indicate a phase of lack of wind (or lack of power in the grid) or a phase of excess wind (or excess power in the grid). This control signal can be the loading or unloading signal and can also come from other plants, e.g., if they generate too little or too much power depending on the wind there. All in all, a balance in power generation is to be achieved, whereby the invention is not to be limited to a single power generation plant but is also to include a whole park of plants (e.g., a wind park or photovoltaic park or a multitude of houses with photovoltaic plants or the whole power grid). Embodiments also relate to a method of buffering energy for at least one power generation plant.

The method includes:
operating an osmosis device in a loading process in which a mixed liquid is separated into a permeate and a concentrate by reverse osmosis at a loading pressure;
storing the permeate in a permeate reservoir;
storing the concentrate in a concentrate reservoir,
   wherein electrical energy (e.g., excess energy) from the power grid or the electrical energy of the at least one power generation plant is utilized.

Embodiments also relate to a method for compensating for a shortage (lack) of produced electrical energy from at least one power generation plant (or a shortage of electricity in the power grid). The method includes:
operating an osmosis device in an unloading process in which a permeate and a concentrate are mixed by forward osmosis to form a mixed liquid;
driving a turbine with the mixed liquid from the osmosis device;
generating and providing electrical power through a generator driven by the turbine.

Embodiments comprise a plurality of advantages:

Their inherent properties in particular meet all the requirements placed on energy storage systems in modern electricity markets. Embodiments of the type presented here enable a major hurdle on the way to a climate-neutral society to be overcome. Embodiment can be used, for example, as grid service providers (i.e., to balance load and supply peaks) or for decentralized energy storage.

Embodiments combine three technologies: two storage technologies and renewable wind, solar, hydro or geothermal power. The two storage technologies are mechanical pumped storage and chemical storage by exploiting the osmosis effect of solutes in a solvent (pressure difference through a semi-permeable membrane). Both storage technologies are combined to form a hybrid storage system and are advantageously integrated locally in the tower of a wind turbine or in houses with photovoltaic systems. Likewise, an existing dam or underground cavities can be utilized as natural height differences. No new, additional space is required.

When integrated in the tower of the wind turbine, only the capacity is limited by the size of the wind turbine. However, due to the sum of all wind turbines in which the storage concept can be installed, the total storage capacity is large enough. Exemplarily, two advantages of this hybrid storage system are that: (i) the storage is located in close proximity to where the electricity is generated, which minimizes transportation losses, and (ii) the useful utilization of previously unused space inside the wind tower. The previously unused space, in turn, provides the infrastructure for the hybrid storage system on the one hand, which is why the investment costs of the storage system are low. On the other hand, the installation of the storage system does not additionally interfere with nature.

The same applies to photovoltaic systems mounted on houses. Here, too, integration can take place within the available space on the roof or in the basement, so that the naturally existing differences in height are available for the desired pressure build-up for utilization of the osmosis effect.

### BRIEF DESCRIPTION OF THE DRAWINGS

The embodiments of the present invention will be better understood by reference to the following detailed description and by the accompanying drawings of the various embodiments, which, however, should not be construed as limiting the disclosure to the specific embodiments, but are for explanation and understanding only.

FIG. 1 shows an energy buffer for a wind turbine according to an embodiment of the present invention.

FIG. 2A,2B show schematic representations of the loading process and the unloading process as they can be controlled by the control device according to embodiment.

FIGS. 3A,3B show the loading process and the unloading process in the exemplary wind turbine.

FIGS. 4A,4B show steps of methods according to embodiments.

### DETAILED DESCRIPTION

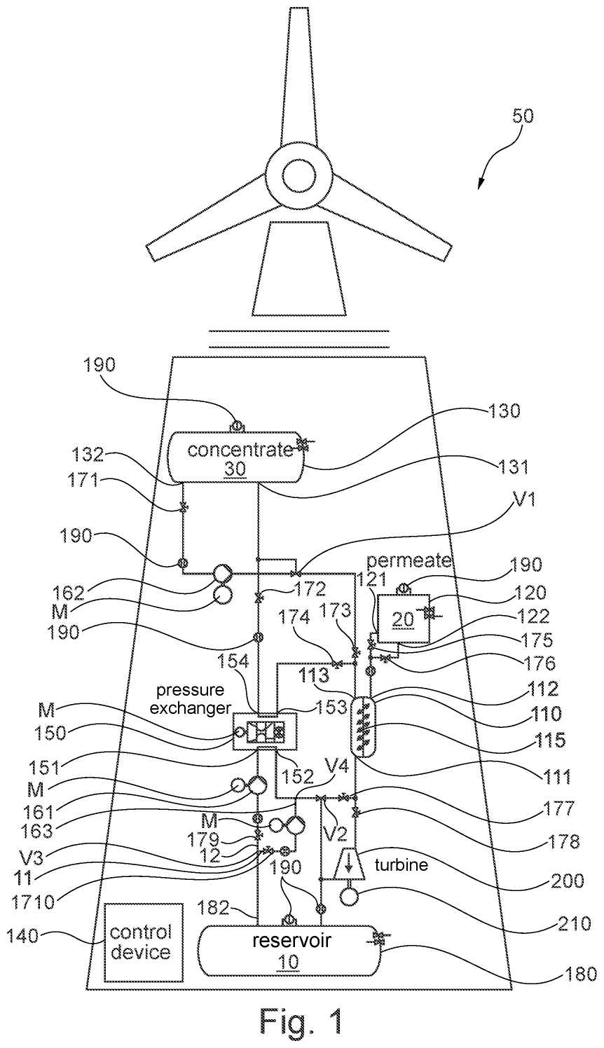

FIG. 1 shows an energy buffer for a power generation plant 50 according to an embodiment of the present invention. The energy buffer includes an osmosis device 110, a permeate reservoir 120, a concentrate reservoir 130, and a control device 140. The osmosis device 110 includes a membrane 115 and is configured to separate a mixed liquid 10 into a permeate 20 and a concentrate 30. The permeate reservoir 120 is in fluid communication with the osmosis device 110 and is configured to store the permeate 20. The concentrate reservoir 130 is in fluid communication with the osmosis device 110 and is configured to store the concentrate 30.

In the following description, the invention is explained on the basis of a wind turbine. It is understood that this is only one embodiment. Instead of the wind power plant, any other power generation plant can be used—in particular one or more photovoltaic plants, hydroelectric plants or geothermal plants. In order to facilitate the comprehensibility of the description, no further reference is made to this.

The control device 140 controls the operation of the energy buffer, for example, whether the osmosis device 110 is operated in forward osmosis mode or reverse osmosis mode. In the forward osmosis (unloading or discharge process), mixing of concentrate 30 and permeate 20 to form the mixed liquid 10 occurs with utilization/generation of osmotic pressure, while in the reverse osmosis (loading process), separation thereof occurs with application of pressure. This application of pressure represents the energy that is stored and can be recovered in the forward osmosis mode.

The shown energy buffer includes a reservoir 180 for the mixed liquid 10 and a turbine 200. The turbine 200 is, for example, a water turbine that couples to a power generator 210 to generate electrical power based on the positive pressure in the mixed liquid 10 during the unloading process.

The mixed liquid 10 includes, for example, a salt water solution as pure as possible (sodium chloride dissolved in pure water) or another salt liquid as pure as possible. Instead of salt, sugar or another soluble substance may also be utilized. The invention is also not necessarily intended to be limited to water as a solvent. It is advantageous if as high an osmotic pressure as possible is achieved, while the membrane 115 should be as durable as possible and should preferably not become clogged (e.g., by impurities in the water). For this reason, natural water such as seawater as mixed liquid 10 or fresh water as permeate 20 is probably unsuitable.

The osmosis device 110 includes an inlet 111, a permeate outlet 112, and a concentrate outlet 113. The inlet 111 is in fluid communication with the reservoir 180 via a pressure exchanger 150, a first pump 161, a third pump 163, and the turbine 200. The elements M are motors that drive the pumps. The reservoir 180 includes an inlet 181 and an outlet 182. The permeate outlet 112 of the osmosis device 110 is fluidly in communication with an inlet 121 and outlet 122 of the permeate reservoir 120. The concentrate reservoir 130 includes an inlet 131 and an outlet 132. The inlet 131 is in fluid communication with the concentrate outlet 113 of the osmosis device 110 via a branch point V1. The outlet 132 of the concentrate reservoir 130 is also in fluid communication with the concentrate outlet 113 of the osmosis device 110 via the branch point V1.

The energy buffer further includes a pressure exchanger 150. The pressure exchanger 150 includes an inlet 151 for the mixed liquid 10 and an outlet 152 for the mixed liquid 10. Further, the pressure exchanger 150 includes an inlet 153 for the concentrate 30 and an outlet 154 for the concentrate 30. The pressure exchanger 150 has its inlet 151 in communication with the outlet 182 of the reservoir 180 via the first pump 161 fluid. Between the outlet 182 of the reservoir 180 and the first pump 161, the mixed liquid 10 is separated to any parts of the mixed liquid 11 and the mixed liquid 12 at a branch V3 (separation point). In this process, the mixed liquid 11 passes through the third pump 163 and the mixed liquid 12 passes through the first pump 161 and the pressure exchanger 150. The mixed liquid 11 and the mixed liquid 12 are combined at the branch V4 (mixing point) at the loading pressure P1. The outlet 152 for the mixed liquid 10 is in fluid communication with the inlet 111 of the osmosis device 110 via the mixing point V4. The concentrate outlet 113 of the osmosis device 110 is in fluid communication with the inlet 153 of the pressure exchanger 150 for the concentrate 30. The outlet 154 for the concentrate 30 of the pressure exchanger 150 is in fluid communication with the inlet 131 of the concentrate reservoir 130.

Between the separation point V3 and the inlet 151 of the pressure exchanger 150 is the first pump 161, which is configured to provide a predetermined loading pressure P1 at the inlet 111 of the osmosis device 110. In the pressure exchanger 150, a pressure P3 is transferred to the concentrate 30 and a portion of the loading pressure P1 is transferred to the mixing liquid 12.

Between the outlet 132 of the concentrate reservoir 130 and the concentrate outlet 113 of the osmosis device 110 is a second pump 162 configured to provide a predetermined concentrate pressure P4 at the concentrate outlet 113 of the osmosis device 110 (during the unloading process).

Between the separation point V3 and the mixing point V4 there is a third pump 163 configured to (also) provide the loading pressure P1 for the mixing liquid 11.

Along the fluid connections between the aforementioned components of the energy buffer, a plurality of valve units 170 (171, 172, . . . ) are provided to either close or open, or even partially throttle, the respective connections in order to control the flow of the respective fluids.

Thus, a first valve unit 171 is configured at the outlet 132 of the concentrate reservoir 130. A second valve unit 172 is arranged between the inlet 131 of the concentrate reservoir 130 and the concentrate outlet 154 of the pressure exchanger 150. A third valve unit 173 is arranged between the concentrate outlet 113 of the osmosis device 110 and the outlet 132 of the concentrate reservoir 130. A fourth valve unit 174 is arranged between the concentrate outlet 113 of the osmosis device 110 and the inlet 151 of the concentrate at the pressure exchanger 150. A fifth valve unit 175 is arranged at the inlet 121 of the permeate reservoir 120. A sixth valve unit 176 is arranged at the outlet 122 of the permeate reservoir 120. A seventh valve unit 177 is arranged between the mixed liquid outlet 152 of the pressure exchanger 150 and the inlet 111 of the osmosis device 110. An eighth valve unit 178 is arranged between the inlet 111 of the osmosis device 110 and the turbine 200. A ninth valve unit 179 is arranged between the separation point V3 and the first pump 161. A tenth valve unit 1710 is arranged between the separation point V3 and the third pump 163.

It is understood that all valve units 170 are arranged to control the corresponding flow paths. Even though multiple branches are possible, only one valve unit 170 need be present along a flow path. Optionally, a three-way valve may be configured at a crossing point. For example, a three-way valve may be provided at a first junction point V1 to optionally connect the concentrate outlet 113 of the osmosis device 110 to the inlet 131 or to the outlet 132 of the concentrate reservoir 130. Another optional three-way valve may be present at a second branch point V2 to optionally connect the inlet 113 of the osmosis device 110 to the reservoir 180 or to the turbine 200. Another three-way valve may be present at a separation point V3 to divide the mixed water 10 between the first and third pumps 161, 163, respectively. A fourth three-way valve may be present at the mixing point V4 to combine the mixed water from the pressure exchanger outlet 152 and the mixed water 11 from the third pump 163.

The first and second branch points V1, V2 provide bypass (safety) conduits. The first branch point V1 allows some or all of the concentrate 30 to flow directly between the osmosis device 110 and the concentrate reservoir 130 (e.g., bypassing the pressure exchanger 150). Similarly, the second branch point V2 allows some or all of the mixed liquid 10 to flow directly between the osmosis device 110 and the reservoir 180 (e.g., bypassing the turbine 200 or the pressure exchanger 150). Therefore, the three-way valves at the first and second branching points V1, V2, respectively, can be utilized to precisely control the pressure ratios, i.e., to achieve the most accurate setting of the loading pressure P1 and the concentrate pressure P4, and to be able to reduce pressure surges of the loading pressure P1 and the concentrate pressure P4 that represent a safety risk.

The optional pressure exchanger 150 is configured to utilize part or all of an outlet pressure P2 at the concentrate outlet 113 of the osmosis device 110 to bring a pressure of the mixed liquid 10 from the reservoir 180 to the loading pressure P1 at the inlet 111 of the osmosis device 110. Thus, this pressure exchanger 150 serves to utilize energy in the outlet pressure P2 at the concentrate outlet 113 of the osmosis device 110 to unload the first or third pumps 161, 163. In other words, the first or the third pump 161, 163 needs less energy since they do not have to provide the predetermined loading pressure P1 at the inlet 111 for the entire mixed fluid 10.

The first pump 161 may be arranged between the separation point V3 and the mixed liquid inlet 151 of the pressure exchanger 150. The second pump 162 may be arranged between the outlet 132 of the concentrate reservoir 130 and the first branch point V1. The third pump 163 may be arranged between the separation point V3 and the mixing point V4.

Optionally, the energy buffer includes additional sensors 190 such as volumetric sensors to detect fluid flows along the flow paths or level sensors to detect fluid levels in the various reservoirs (permeate reservoir 120, concentrate reservoir 130, reservoir 180). The permeate reservoir 120, concentrate reservoir 130, and reservoir 180 also include valves to allow air to flow in and out during operation.

The control device 140 is configured to control at least some or all of the valve units 170 and to receive sensor data via the further sensors 190, which can be utilized for monitoring and optimization. In addition, the control device 140 may be configured to control the first pump 161 or the third pump 163 during the loading process to control the elevation pressure P3 (reduced outlet pressure) or the loading pressure P1 at the inlet 111 of the osmosis device 110 and to control the second pump 162 during the unloading process to control the concentrate pressure P4 at the concentrate outlet 113 of the osmosis device 110.

It is understood that the components of the energy buffer are interconnected by pipe connections and the valves, measuring, control and safety devices are configured to allow permanent control.

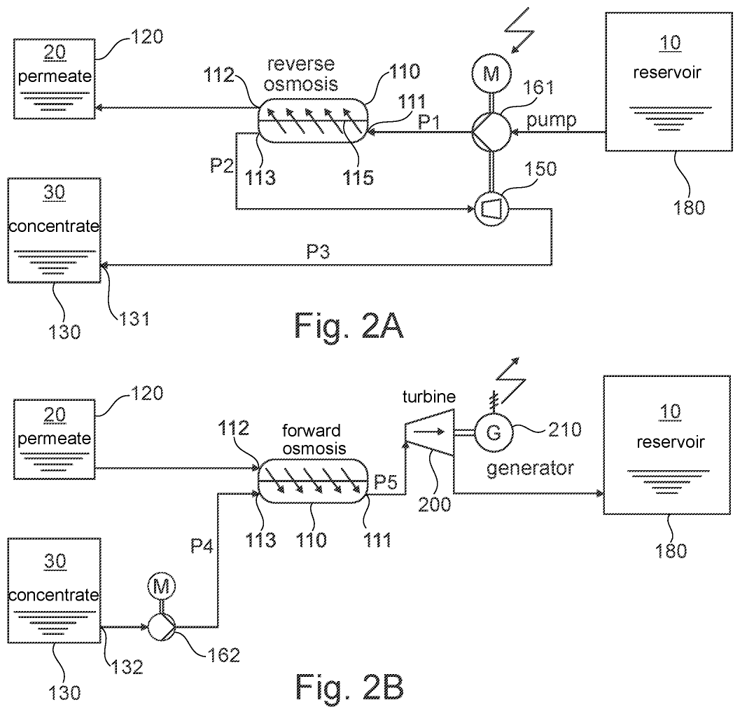

FIG. 2A shows a schematic representation of the loading process that can be controlled by the control device 140 according to embodiments.

During the loading process, mixed liquid 10 is withdrawn from the reservoir 180 via the first pump 161 or the third pump 163 and optionally supported by the pressure exchanger 150 and fed to the inlet 111 of the osmosis device 110 at the loading pressure P1. In the osmosis device 110, with utilization of the membrane 115 the concentrate 30, which is discharged via the concentrate outlet 113, is separated from the permeate 20, which is discharged via the permeate outlet 112. The permeate 20 is fed to the permeate tank 120 via the permeate outlet 112. The concentrate 30 passes from the concentrate outlet 113 to the pressure exchanger 150 at an outlet pressure P2. The pressure exchanger 150 reduces the outlet pressure P2 to a reduced outlet pressure P3, while simultaneously utilizing the pressure (or corresponding energy) to relieve the first pump 161 and/or the third pump 163 so that, in part, the outlet pressure P2 is utilized to build up the loading pressure P1 for the mixed liquid 12. After the pressure exchanger 150, the concentrate 30 reaches the inlet 131 of the concentrate tank 130 with the reduced outlet pressure P3.

Control is again based on sensors 190, as shown in FIG. 1, by the control device 140. In particular, the control device 140 triggers the loading process when an excess of energy is available (e.g., as energy peaks) to achieve smoothing of the production of electrical energy by the wind turbine or by other power generators.

FIG. 2B shows a schematic representation of the unloading process that can be controlled by the control device 140 according to embodiments. Here, the flow directions are reversed. The concentrate 30 is pumped from the outlet 132 of the concentrate reservoir 130 via the second pump 162 to the concentrate outlet 113 of the osmosis device 110 with a concentrate pressure P4.

Further, permeate 20 is directed from permeate reservoir 120 to permeate outlet 112 of osmosis device 110. In the osmosis device 110, mixing of the permeate 20 and the concentrate 30 occurs via forward osmosis, utilizing osmotic pressure. Therefore, the mixed liquid 10 leaves the osmosis device 110 at an overpressure (turbine inlet pressure P5), which subsequently drives the turbine 200. A generator 210 is driven via the turbine 200 to generate electricity. Downstream of the turbine 200, the expanded mixed liquid 10 is fed to the reservoir 180.

The unloading process as well as the loading process is controlled by the control device 140, which controls the second pump 162, the turbine 200 and the various valve units 171, 172, . . . (see FIG. 1) to generate a corresponding flow with predetermined pressures P1, P2, . . . in the corresponding directions. The arrows in the figures indicate the flow directions.

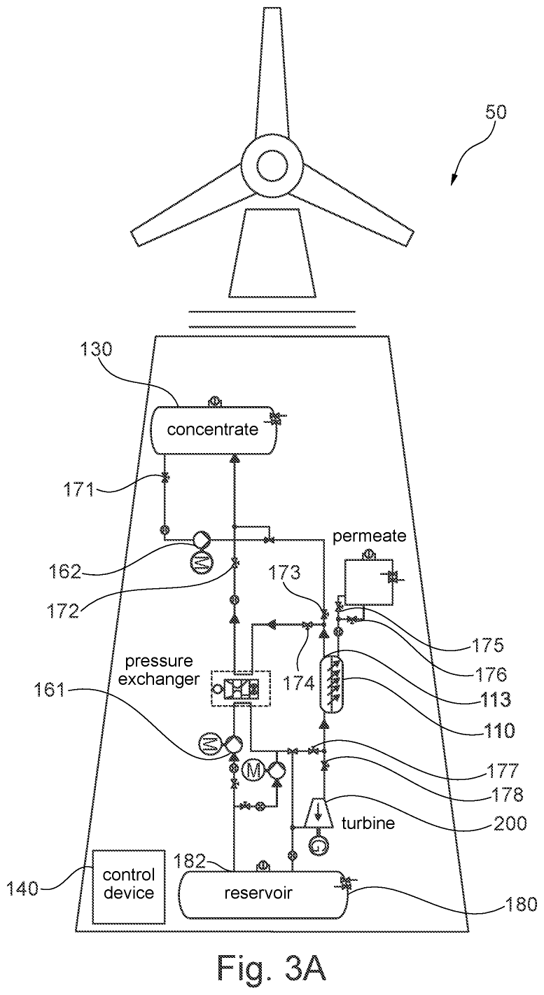

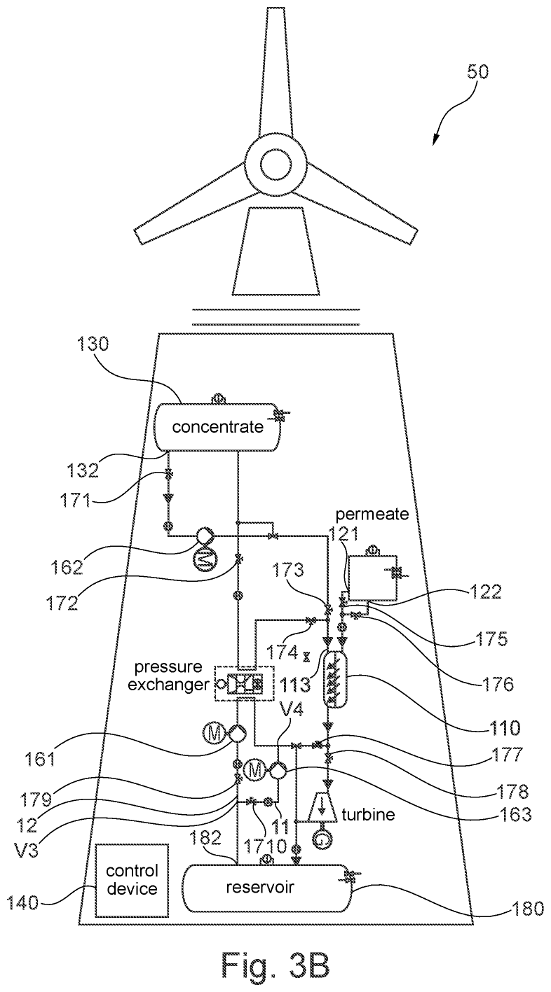

FIG. 3A shows the loading process in the exemplary wind turbine 50, as already shown schematically in FIG. 2A. The lines with the arrows show the unblocked lines during the loading process, while the thinner lines show closed lines. The valves opened for this purpose are not filled, while the closed valves are filled in black. Specifically, the following valve units may be closed during loading:
the first valve unit 171, the third valve unit 173, the sixth valve unit 176, the eighth valve unit 178 and branch point V2.

Accordingly, the following valve units are open:
the second valve unit 172, the fourth valve unit 174, the fifth valve unit 175, the seventh valve unit 177, the ninth valve unit 179, and the tenth valve unit 1710.

Flow of the mixed liquid 10, permeate 20, and concentrate 30 is effected by the first pump 161 and the third pump 163, while the second pump 162 may be turned off. As previously described, the pressure exchanger 150 can be utilized to recover energy so that the reduced outlet pressure P3 is just high enough to allow the concentrate 30 to enter the concentrate reservoir 130.

The opening or closing of the valve units 171, 172, . . . and the operation of the first/second/third pump 161, 162, 163 is controlled by the control device 140, as already explained. For the sake of clarity, the corresponding control lines or control signals are not shown in the figures.

FIG. 3B shows the unloading process as already schematically illustrated in FIG. 2B, specifically in the exemplary wind turbine 50. The lines with the arrows again show the opened lines during the unloading process, while the thin lines show closed connections. The valves opened for this purpose are drawn not filled, while the closed valves are filled in black. Accordingly, in this mode of operation, the following valve units are closed:
the second valve unit 172, the fourth valve unit 174, the fifth valve unit 175, the seventh valve unit 177, and the branch point V2.

The following valve units are open:
the first valve unit 171, the third valve unit 173, the sixth valve unit 176, the eighth valve unit 178.

The ninth valve unit 179 and the tenth valve unit 1710 may be open or closed. Since the first pump 161 and the third pump 163 do not pump in this mode, no mixed water 10 flows between the reservoir 180 and the pressure exchanger 150.

Accordingly, also at the branching point V1, the flow from the outlet 132 of the concentrate reservoir 130 has been switched to pass, that is, to the concentrate outlet 113 of the osmosis device 110. Therefore, during the unloading process, the concentrate 30 is pumped from the concentrate reservoir 130 to the concentrate outlet 113 of the osmosis device 110 by the second pump 162 at the concentrate pressure P4. Simultaneously, permeate 20 is gravity fed from permeate reservoir 120 to permeate outlet 112 of osmosis device 110. In the osmosis device 110, mixing of the concentrate 30 and permeate 20 occurs, while the osmotic pressure and concentrate pressure P4 combine to form the turbine pressure P5 from the osmosis device 110. The mixture is directed to the turbine 200 where it is utilized to generate power (e.g., electricity using a generator). Thereafter, the mixed liquid 10 is stored again in the reservoir 180.

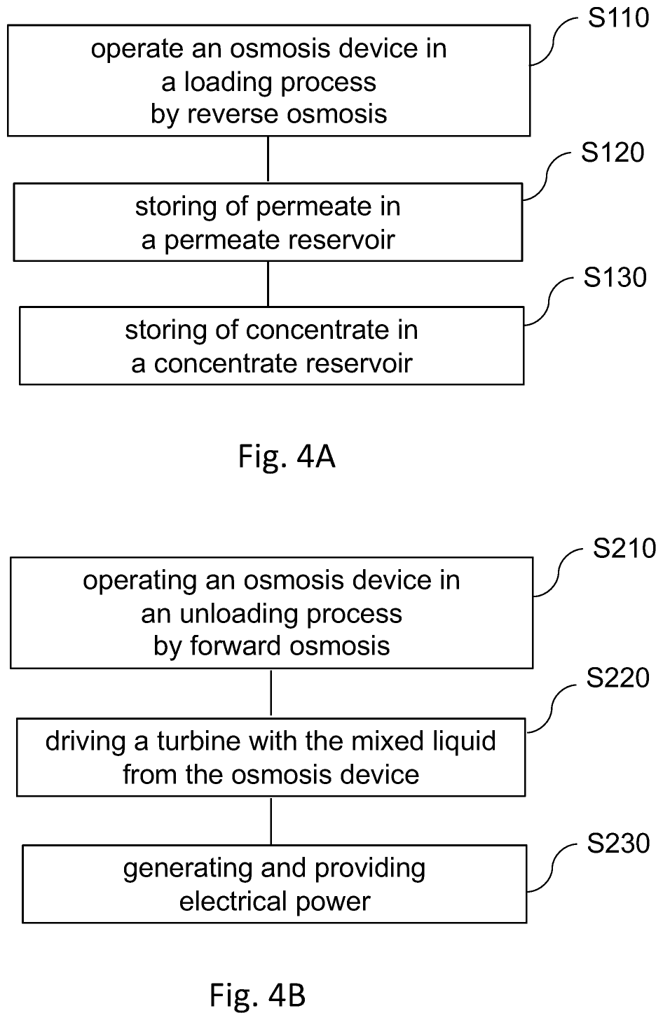

FIG. 4A shows a schematic flow diagram for a method of buffering energy for the at least one wind turbine 50. The method includes:
operate S110 an osmosis device 110 in a loading process in which reverse osmosis is used to separate a mixed liquid 10 having a loading pressure P1 into a permeate 20 and a concentrate 30;
storing S120 of permeate 20 in a permeate reservoir 120;
storing S130 of concentrate 30 in a concentrate reservoir 130,
   wherein excess energy from the power grid or the electrical energy of the at least one wind turbine 50 is utilized.

FIG. 4B shows a schematic flow diagram for a method of compensating for a shortage of produced electrical energy in the power grid or from at least one wind turbine 50. This method includes:
operating S210 an osmosis device 110 in an unloading process in which a permeate 20 and a concentrate 30 are mixed by forward osmosis to form a mixed liquid 10;
driving S220 a turbine 200 with the mixed liquid 10 from the osmosis device 110;
generating and providing S230 electrical power by a generator 210 driven by the turbine 200.

As already written, salt water in particular can be utilized as the mixed liquid 10, with sodium chloride being added to the purest possible water. In the following, it is assumed by way of example that the mixed liquid 10 is salt water. For example, the mixed liquid 10 may comprise a salt concentration of at least 3% or more 5% in the reservoir 180 and a concentration of at least 20% or up to 30% in the concentrate reservoir 130 (in mass percentages), while nearly pure water is present in the permeate reservoir 110. The upper limit results from the condition that the concentrate 30 should still dissolve the salt. Clogging due to precipitating salt should be avoided. However, this depends largely on the salt used and the ambient conditions (e.g., temperature).

According to embodiments, the loading process and unloading process of the energy buffer may also be summarized as follows:

### A. Loading Process

During the loading process, the first pump 161 and/or the third pump 163 deliver the exemplary salt water 10 into the osmosis device 110 with the membrane 115. The pressure ratio in the first and/or the third pump 161, 163 is selected depending on the membrane (strength) and can be between 0 and 1000 bar. The membrane 115 separates the incoming salt water 10 into two streams, a stream of very pure water (permeate 20) and a stream with a high concentration of soluble components (concentrate 30). The membrane 115 comprises a pressure difference to be overcome for the first and/or third pump 161, 163. This is based on the osmosis principle. The membrane 115 is semi-permeable, i.e. ideally only permeable to the water in both directions. If the permeate 20 is present on one side of the membrane 115 and the concentrate 30 on the other side, the permeate 20 strives to pass through the membrane 115 and mix with the concentrate 30. This effort causes a pressure difference called osmotic pressure. This pressure is overcome by the first and/or third pumps 161, 163 to separate the salt water 10 into permeate 20 and concentrate 30.

The concentrate 30 exiting the membrane 115 flows through the pressure exchanger 150, which reduces the pressure of the concentrate 30 while increasing the pressure of the mixing fluid 12. The pressure of the concentrate 30 is utilized to increase the pressure of the mixed liquid 12 from the inlet 151 to the outlet 152 of the osmosis device 150. The pressure of the concentrate 30 is reduced enough so that the concentrate 30 can still overcome the height difference to the concentrate reservoir 130 after flowing through the pressure exchanger 150.

This difference in height between the supply reservoir 180 and the concentrate reservoir 130 causes a hydrostatic pressure. The first pump 161 in conjunction with the pressure exchanger 150 as well as the third pump 163 overcome this pressure difference in addition to the pressure difference in the membrane 115. The height storage of the concentrate 30 corresponds to the principle of a pumped storage power plant. Since embodiments specifically utilize the height difference in the wind turbine 50, the energy buffer can be considered a hybrid energy storage system that not only provides osmotic energy storage but also takes advantage of a pumped storage system.

The permeate 20 passing through the membrane 115 is stored in the permeate reservoir 120. If the permeate reservoir 120 is also located at the top of the tower, another pump is utilized (not shown in FIG. 3A) to deliver the permeate 20 to the top.

For controlling the pumps 161, 162, 163, the valves 171, 172 . . . and other valves and components to be controlled during the loading process, the control device 140 is provided inside the tower (see FIG. 3A).

The loading process is completed when the concentrate tank 130 and the permeate tank 120 are filled.

The loading process described with the components mentioned represents one possible configuration of the hybrid accumulator. In other embodiments, the addition of further membranes, pumps, pressure exchangers, valves, etc. and a suitable interconnection of these components reduce, among other things, the required loading power and time.

### B. Unloading Process

When discharging the energy buffer, the second pump 162 delivers the concentrate 30 from the concentrate reservoir 130 to the osmosis device 110. The delivery pressure can be between 0 bar and the osmotic pressure. It has been found advantageous to utilize, for example, half of the osmotic pressure, the osmotic pressure depending, for example, on the selected concentrations.

The permeate 20 from the permeate reservoir 120 also flows to the membrane 115 and, due to the osmotic pressure drop across the membrane 115, reaches the concentrate side, where it mixes with the concentrate 30 and leaves the osmosis device 110 as salt water 10. The salt water 10 is then expanded in the turbine 200 and stored again in the reservoir 180. The turbine 200 drives the generator 210, which generates electricity.

The unloading process is finished when the reservoir 180 is filled.

The control device 140 is again used to control the pumps, valves, turbine, generator, etc. and other fittings and components to be controlled during the unloading process.

The described unloading process with the mentioned components represents the simplest configuration of the hybrid accumulator. By adding further membranes, pumps, pressure exchangers, turbines, generators, valves, etc., as well as a suitable interconnection of these components, the discharge power and time gained can be increased, among other things.

The pressures set by the control device 140 are defined in particular by the osmotic pressure. During the loading process, at least the osmotic pressure is generated as loading pressure P1 by the first pump 161 in conjunction with the pressure exchanger 150 and by the third pump 163. During the unloading process, for example, half of the osmotic pressure is generated as concentrate pressure P4 by the second pump 162. For a concentrate 30 with a salt concentration of only 3.5 percent, compared to fresh water, the osmotic pressure at 10° C. is, for example, about 28 to 32 bar. At higher concentrations, it is significantly higher. On the other hand, if the mixed water 10 is a 35 percent salt solution, then at least an osmotic pressure of 200-500 bar is required for separation. Accordingly, depending on the volume flow rate, a lot of energy is required or can be obtained in case of forward osmosis. Thus, the control device 140 can react flexibly to energy peaks/energy dips.

For example, during the loading process at a mixed water concentration of about 3.5%, a permeate concentration of about 0% and a concentrate concentration of 20%, the loading pressure P1 and outlet pressure P2 are between 150 and 250 bar and the reduced outlet pressure P3 is between 0 and 50 bar.

For example, during the loading process at a mixed water concentration of about 3.5%, a permeate concentration of about 0% and a concentrate concentration of 30%, the loading pressure P1 and the outlet pressure P2 are between 200 and 500 bar and the reduced outlet pressure P3 is between 0 and 50 bar.

For example, during the unloading process at a mixed water concentration of approx. 3.5%, a permeate concentration of approx. 0% and a concentrate concentration of 20%, the concentrate pressure P4 and turbine inlet pressure P5 are between 0 and 250 bar.

For example, during the unloading process at a mixed water concentration of approx. 3.5%, a permeate concentration of approx. 0% and a concentrate concentration of 30%, the concentrate pressure P4 and the turbine inlet pressure P5 are between 0 and 500 bar. Embodiments are not intended to be limited to specific pressure ratios. They can also be chosen differently and depend on the one hand on the chosen fluid or concentrations, but also on the membrane 115 used and the available height for the reservoirs 120, 130. The concentrate reservoir 130 is optionally located above the permeate reservoir 120 and should be installed as far as possible in the upper area of the wind turbine 50. The size of the permeate reservoir 120 may be, for example, between 90% and 10% of the size of the reservoir 180, and the concentrate reservoir 130 may accordingly be, for example, between 10% and 90% of the size of the reservoir 180.

A major advantage of the hybrid energy storage system is that each bar of additional pressure corresponds to a water column of about 10 m (i.e. 100 bar corresponds to a height of about 1,000 m). If the same storage capacity is to be achieved in a pure water pumped storage facility, it would have to comprise a multiple of the height of the largest wind turbines available. Or, to put it another way, large amounts of energy can be stored with relatively small volumes of liquid.

Embodiments combine the high storage capacity with a flexible control system, whereby the control system can also be implemented in a coordinated manner for multiple wind turbines (or a wind farm or the power grid). Thus, according to embodiments, it is possible for the control unit 140 to receive corresponding signals from other wind turbines to store their excess energy using inverse osmosis. In this way, the energy buffer can be operated not only by energy from the respective wind turbine itself, but also via an external energy supply (from other wind turbines or also other electricity sources, i.e. the power grid).

For this purpose, the control device 140 may receive an (external) control signal indicating whether there is a need for power storage or a lack of power in the power system. Based on this (external) signal, the control device 140 operates the energy buffer either in the unloading process or in the loading process, or shuts down the energy buffer completely (e.g., by closing all valves) to bring it back into operation when needed.

The wind turbine can be located on land or in the sea (offshore), whereby in the latter case, the reservoir 180 can also be arranged below the water surface or on the seabed, for example. In this way, the height difference can be further increased. The turbine 200 can, for example, be located at approximately the same level as the reservoir 180 in order to achieve the highest possible inlet pressure P5 for the mixed liquid 10.

As explained above, other power generation plants can be utilized instead of or in addition to the wind turbine described It is also possible to combine any power generation plants.

The features of the invention disclosed in the description, the claims and the figures may be essential to the realization of the invention either individually or in any combination.

### LIST OF REFERENCE SIGNS

10 mixed liquid
20 permeate
30 concentrate (retentate)
50 wind turbine
110 osmosis device
111 osmosis device inlet
112 permeate outlet
113 concentrate outlet
120 permeate reservoir
121,122 inlet, outlet of permeate reservoir
130 concentrate reservoir
131, 132 inlet, outlet of the concentrate reservoir
140 control device
150 pressure exchanger
151, 152 inlet, outlet for mixed liquid at pressure exchanger
153, 154 inlet, outlet for the concentrate at the pressure exchanger
161, 162, 163 pumps
170, 171, . . . , 1710 valve unit(s), valves
180 reservoir
190 sensors (for measuring volumes, pressure, level, etc.)
200 turbine
210 generator
P1 loading or charging pressure
P2 outlet pressure of the membrane of the concentrate during loading
P3 reduced outlet pressure of the concentrate after flowing through the pressure exchanger
P4 concentrate pressure at membrane inlet during discharge
P5 turbine inlet pressure
V1 safety (three-way) valve during unloading
V2 safety (three-way) valve during loading
V3 separation point of mixed liquid 10 to mixed liquid 11 and to mixed liquid 12
V4 mixing point of mixed liquid 11 and mixed liquid 12 to mixed liquid 10

1. An energy buffer for at least one power generation plant from a time-varying energy source, the energy buffer including:
an osmosis device configured to:
in a loading process, separate a mixed liquid with a loading pressure into a permeate and a concentrate, or
in an unloading process, mix the permeate with the concentrate while providing an osmotic pressure to form the mixed liquid;
a permeate reservoir fluidly communicating with the osmosis device and configured to store the permeate;
a concentrate reservoir fluidly communicating with the osmosis device and configured to store the concentrate; and
a control device configured to control the following functions:
the loading process with utilization of energy from the at least one power generation plant, the loading process being started in response to a loading signal indicating an excess of electrical energy, or
the unloading process while providing electrical energy, the unloading process being started in response to an unload signal indicating a lack of electrical energy.

2. The energy buffer of claim 1, further comprising
a pressure exchanger configured to partially utilize an outlet pressure of the osmosis device for the concentrate to generate the loading pressure of the osmosis device.

3. The energy buffer of claim 1, wherein the concentrate reservoir is arranged above the permeate reservoir to maintain a hydrostatic pressure of the permeate lower than a hydrostatic pressure of the concentrate.

4. The energy buffer of claim 2, further including at least one of the following:
a first pump configured to pump the mixed liquid through the pressure exchanger and, during the loading process, to bring the loading pressure at the osmosis device for the mixed liquid to a predetermined value above the osmotic pressure;
a second pump configured to feed the concentrate from the concentrate reservoir to the osmosis device at a predetermined concentrate pressure during the unloading process;
a third pump configured to pump the mixed liquid bypassing the pressure exchanger and, during the loading process, to bring the loading pressure at the osmosis device for the mixed liquid to a predetermined value above the osmotic pressure;
a plurality of valve units configured to control one or more of the following flows: flow of mixed liquid, flow of permeate, flow of concentrate;
a reservoir for the mixed liquid to enable a closed liquid circuit.

5. The energy buffer of claim 4, wherein the control device is further configured to control at least one of the following functions:
actuating the first pump and/or the second pump and/or the third pump and/or the valve units to achieve the predetermined loading pressure and/or the predetermined concentrate pressure, wherein the predetermined concentrate pressure during the unloading process is equal to or lower than the osmotic pressure or equal to half an osmotic pressure.

6. The energy buffer according to claim 1, wherein the osmosis device comprises a membrane configured to separate the mixed liquid at a concentration of at least 3% or at least 5% into the permeate and the concentrate.

7. The energy buffer of claim 6, wherein the membrane is configured to allow operation with a concentration of the concentrate of at least 10% or of at least 20%.

8. The energy buffer according to claim 1, wherein the mixed liquid is a pure salt solution and the energy buffer is a closed system without mass transfer with the environment.

9. A power generation plant from a time-varying energy source, wherein the power generation plant is a wind power plant or a photovoltaic power plant or a hydroelectric power plant or a geothermal power plant or a combination thereof, comprising:
an energy buffer according to any of the preceding claims.

10. The power generation plant of claim 9, wherein the energy buffer is a hybrid storage device in which:
the permeate reservoir is located below the concentrate reservoir in a tower of the wind turbine or in a house with the photovoltaic system, and
the reservoir for the mixed liquid is arranged above, on or below a ground surface or water surface,
to achieve hybrid energy storage as a combination of osmotic energy storage with mechanical pumped storage.

11. The power generation plant according to claim 9, further comprising at least one turbine configured to utilize the osmotic pressure of the mixed liquid generated by the osmosis device for electrical power generation.

12. The power generation plant according to claim 9, wherein the control device is further configured to receive the control signal and, based thereon, start the loading process or the unloading process, the control signal indicating one of the following:
a period of wind shortage or sunlight shortage,
a phase of wind surplus or sunlight surplus,
a phase of lack of power supply in a power system,
a phase of excess power supply in the power grid.

13. A method of buffering energy for at least one power generation plant from a time-varying energy source, the method including:
operating an osmosis device in a loading process in which a mixed liquid with a loading pressure is separated into a permeate and a concentrate by reverse osmosis;
storing the permeate in a permeate reservoir;
storing the concentrate in a concentrate reservoir.
wherein energy of the at least one power generation plant is utilized.

14. A method for compensating for a shortage of produced electrical energy from at least one power generation plant or for compensating for a shortage of electricity in a power grid, the method including:
operating an osmosis device in an unloading process in which a permeate and a concentrate are mixed by forward osmosis to form a mixed liquid;
driving a turbine with the mixed liquid from the osmosis device;
generating and providing electric power by a generator driven by the turbine.

15. The energy buffer according to claim 1, wherein the excess or lack of electrical energy comes from the fluctuating power generation plant itself, or from other plants, or from the power grid.
